(19) United States
(12) Patent Application Publication
(10) Pub. No.: US 2005/0177873 A1
(43) Pub. Date: Aug. 11, 2005

(54) FILE ACCESS CONTROLLING METHOD AND FILE ACCESS CONTROLLING SYSTEM FOR DIGITAL RIGHTS MANAGEMENT

(76) Inventors: YI-LIN WU, Taipei City (TW); I-TA WU, Chia-I City (TW); Shih-Jong Su, Taipei City (TW); Quo-Lung Chang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,133

(22) Filed: Feb. 3, 2005

(30) Foreign Application Priority Data
Feb. 10, 2004 (TW) 093201868

(51) Int. Cl. H04L 9/00

(52) U.S. Cl. 726/26; 713/165

(57) ABSTRACT

A file access controlling method applied to a network for controlling access of a file transferred via a predetermined transmission scheme. The file access controlling method includes obtaining characteristic data corresponding to the file, and comparing a look-up table with the characteristic data, wherein if the look-up table includes a record corresponding to the characteristic data, an access limitation is imposed on the file according to the record to control access of the files.

### BACKGROUND OF INVENTION

1. Field of the Invention

The invention relates to a file access controlling method and a file access controlling system, and more particularly, to a file access controlling method and a file access controlling system utilized for digital rights management (DRM).

2. Description of the Prior Art

Generally speaking, in a computer network, methods of sharing files can be mainly defined as two following structures, client-server and peer-to-peer structures. It is well-known that the client-server structure comprises a server and at least one client. The files are transferred through data transmission mediums (for example, wire or wireless networks), and all files have to be transferred through the above-mentioned server. For example, if a first client wants to share a file, the first client has to upload the file in the server. On the other hand, when a second client wants to use the file shared by the first client, the second client has to download the file from the server.

The aforementioned client-server structure has some advantages. For example, as mentioned above, all files have to transferred through the server, therefore, it is easy to control access of the files. For example, all we have to do is to delete illegal media data or unauthorized software from the server so that the client cannot obtain the illegal media data or the unauthorized software anymore. Furthermore, we can perform a digital rights management (DRM) operation on media data or a software program stored in the server to impose access limitations on the above-mentioned media data or the software programs. Therefore, the client can only obtain processed media data (such as demo songs) or processed software (such as software trial versions) so that the prior art client-server structure can indeed achieve the purposes of controlling access of the files.

However, the client-server structure also has some disadvantages. For example, the service provider of the server requires a staff and needs to spend time and money on setting up the file access control. Furthermore, when the clients are connected to the server, the service provider has to provide needed transmission bandwidth for clients to access the server smoothly. When the number of clients is quite huge, the bandwidth is enormous, too. In addition, because the shared data or files are all stored in the server, the service provider has to provide huge storage space. However, when the storage space is limited because of limited costs, the service provider must determine what data is to be stored in the server. This reduces the convenience of sharing and exchanging the data or the files.

Therefore, a prior art peer-to-peer structure has been developed. Under the peer-to-peer structure, all data to be shared are provided by clients. In other words, if a client has to share a specific file, another client provides the specific file and transfers the specific file to the client. Therefore, transmission bandwidth and the storage space are all provided by clients. In addition, the conveniences of sharing the data and exchanging the data are increased (because the data can be shared and is not limited by the storage space of the server). Therefore, the service provider only needs to provide related programs for peer-to-peer transmission, and does not have to provide a lot of costs. This increases the convenience of sharing and exchanging the data or the files.

Similarly, the peer-to-peer structure also has corresponding disadvantages. Generally speaking, the peer-to-peer structure is based on the data exchange between clients. That is, the data or files transmission is not controlled by the server. Therefore, it is hard to control the data or files on the network. For example, unauthorized software or media data can be easily shared on the network. Therefore, when the data are exchanged easily, legal software providers or digital media providers cannot be effectively protected by their copyrights, and a major problem ensues.

### SUMMARY OF INVENTION

It is therefore a primary objective of the claimed invention to provide a file access controlling method and a file access controlling system, to solve the above-mentioned problem.

According to an exemplary embodiment of the claimed invention, a file access controlling method applied to a network for controlling access of a file transferred via a predetermined transmission scheme is disclosed. The file access controlling method comprises: establishing a look-up table to store a plurality of records, wherein each record corresponds to a specific access limitation and specific characteristic data; obtaining characteristic data corresponding to the file; and comparing the characteristic data with the look-up table, and if the look-up table comprises a record corresponding to the characteristic data, imposing an access limitation on the file according to the file for controlling access of the file.

In addition, a file access controlling system applied to a network for controlling access of a file transferred via a predetermined transmission scheme is disclosed. The file access controlling system comprises: a first memory module for storing a look-up table, wherein the look-up table stores a plurality of records, where each record corresponds to a specific access limitation and specific characteristic data; a detecting module for obtaining characteristic data corresponding to the file; and a controlling module coupled to the first memory module and the detecting module for comparing the characteristic data with the look-up table, wherein if the look-up table comprises a record corresponding to the characteristic data, the controlling module imposes an access limitation on the file according to the record for controlling access of the file.

The present invention file access controlling method and file access controlling system are capable of accurately controlling the data or the file transferred on the network, and imposing a predetermined process on the data or the file, which are not authorized, so that the unauthorized data or unauthorized media transferred in an peer-to-peer transmission on the network can be managed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a file access controlling system according to the present invention.

FIG. 2 is a flow diagram illustrating file access controlling system shown in FIG. 1 performing the file access controlling operation.

FIG. 3 is a diagram of a look-up table shown in FIG. 1.

### DETAILED DESCRIPTION

In the following disclosure, a peer-to-peer transmission method is utilized for illustration. Please note that the peer-to-peer transmission method is only utilized as a preferred embodiment, not a limitation.

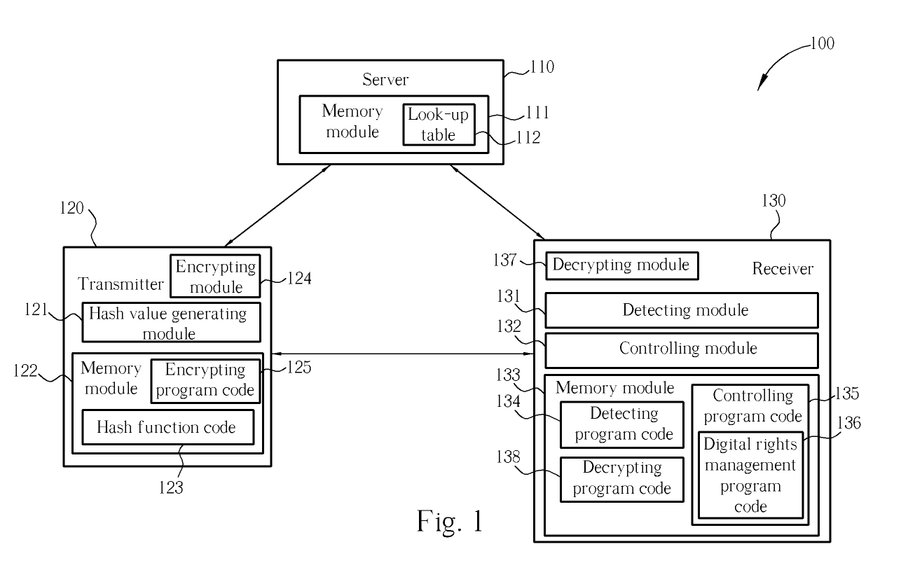

Please refer to FIG. 1, which is a diagram of a file access controlling system 100 according to the present invention. As shown in FIG. 1, the file access controlling system 100 comprises a server 110, a transmitter 120 for transferring a file, and a receiver 130 for receiving the file transferred by the transmitter. The server comprises a memory module 111 for storing a look-up table 112. The transmitter 120 comprises a hash value generating module 121, an encrypting module 124, and a memory module 122 for a hash function code 123, and an encrypting code 125. The transmitter 130 comprises a detecting module 131, a controlling module 132, a decrypting module 137, and a memory module 133 for storing a detecting program code 134, a controlling program code 135, and a decrypting program code 138. Furthermore, in this embodiment, the controlling program code 135 comprises a digital rights management (DRM) program code 136. In addition, the function and the operation of the file access controlling system 100 are illustrated as follows.

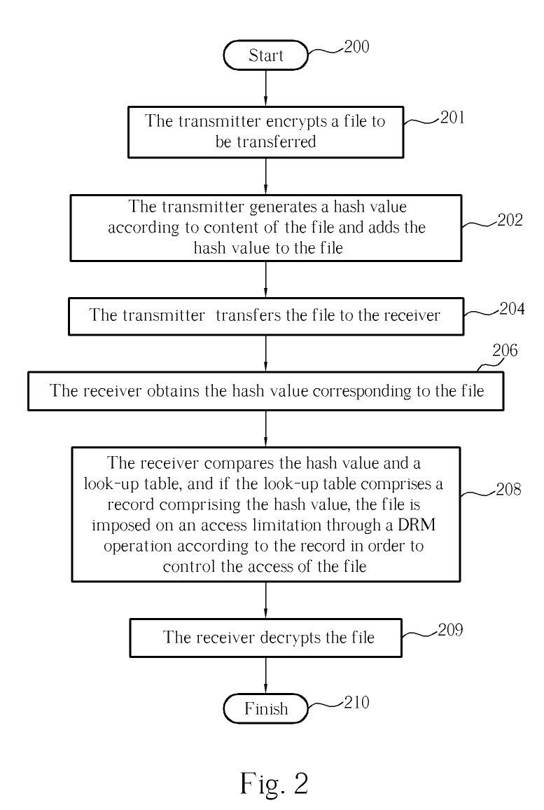

Please refer to FIG. 2, which is a flow diagram illustrating the file access controlling system 100 performing the file access controlling operation. The operation of the file access controlling system 100 comprises following steps:

Step 200: Start;

Step 201: The transmitter 120 encrypts a file to be transferred;

Step 202: The transmitter 120 generates a hash value according to content of the file and adds the hash value to the file;

Step 204: The transmitter 120 transfers the file to the receiver 130;

Step 206: The receiver 130 obtains the hash value corresponding to the file;

Step 208: The receiver 130 compares the hash value and a look-up table, and if the look-up table comprises a record comprising the hash value, the file is imposed on an access limitation through a DRM operation according to the record in order to control the access of the file;

Step 209: The receiver 130 decrypts the file; and

Step 210: Finish.

First of all, the transmitter 130 sends a request to the transmitter 120 through a peer-to-peer transmission mechanism for downloading a file. Before the transmitter 120 outputs the needed file to the receiver 130 (step 200), the encrypting module 124 in the transmitter 120 executes the encrypting program code 125 (step 201) to encrypt the file. Please note that the encryption and the decryption methods are well known by those skilled in the art, and thus further discussion is omitted here.

And then, the hash value generating module 121 in the transmitter 120 executes the hash function code 123 stored in the memory module 122 for generating a hash value according the content and a hash function. Furthermore, the hash value generating module 121 adds the hash value to the file (step 202). Please note that the hash function and the operation of calculating the hash value are well-known, and are thus omitted here. Theoretically, files having the same content have the same hash value. In other words, each file corresponds each hash value. And the purpose of adding the hash value to the file is to make the receiver 130 capable of quickly and easily distinguishing the file type and the file content of the file.

Furthermore, the transmitter 120 transfers the file to the receiver 130 (step 204) through the network (wire or wireless networks). After the receiver 130 smoothly receives the file, the receiver 130 utilizes the detecting module 131 in the receiver 130 to execute the detecting program code 134 stored in the memory module 133 in order to obtain the hash value (step 206). In addition, the receiver 130 simultaneously utilizes the controlling module 135 to execute the controlling program code 135 in order to compare the hash value with the look-up table 112 stored in the memory module 111 of the server 100. In this embodiment, if the look-up table 112 comprises a record corresponding to the hash value, the controlling module 135 executes the digital rights management program code 136 of the controlling program code 135 in order to impose an access limitation on the file for further controlling the access of the file.

After the above steps are executed completely, the decrypting module 137 in the receiver 130 executes the decrypting program code 138 (step 209) stored in the memory module 133 to decrypt the file. Here, the whole operation of the file access controlling system 100 is finished. (step 210)

Here, another embodiment is utilized to further illustrate how to control the access of a file. Generally speaking, the service provider provides a specific software program to the transmitter 120 and the receiver 130. And the transmitter 120 and the receiver 130 have to install the specific program to achieve peer-to-peer transmission and to exchange the shared files. Furthermore, the service provider negotiates with legal copyright owners to obtain a specific program controlling method (that is the above-mentioned access limitation) in order to maintain copyrights of legal programs or media. For example, for a music song published by a record company, the record company may only permit the song to be listened to three times. Or, for a software program disclosed by a software owner, the software owner may only permit the software program to be used for 30 days. Surely, more complicated access controlling methods can also be used. For example, for a song of a specific singer or a specific application software, more complicated access limitations are imposed on the song or the application software. Therefore, the service provider finally establishes the corresponding look-up table 112 in the server 110 according to the negotiated results of access controlling methods, and the service provider stores the look-up table 112 in the memory module 111 of the server.

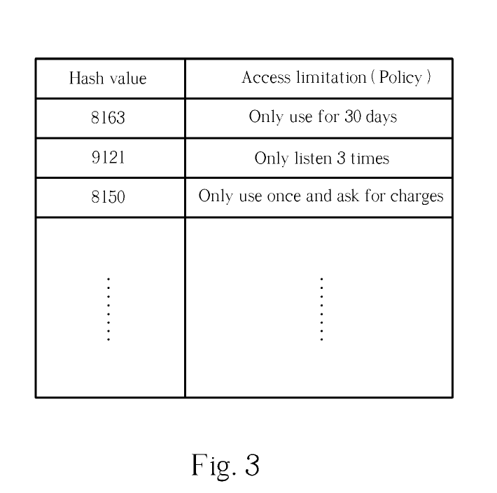

Please refer to FIG. 3, which is a diagram of the look-up table 112 shown in FIG. 1. As mentioned above, because a file corresponds to a specific hash value, the access limitation (or the access policy) is known by comparing the hash value with the look-up table 112. For example, if a predetermined file has a hash value 8163, and if the file limitation is “only use for 30 days” (please note that the file limitation is obtained by negotiating with the copyright owner or by other methods), the look-up table 112 comprises corresponding records.

As mentioned above, the transmitter 120 and the receiver 130 install the specific software program for the peer-to-peer transmission mechanism. And the specific software program comprises the above-mentioned encrypting program code 125, the decrypting program code 138, the hash function code 123, the detecting program code 134, the controlling program code 135, and the DRM program code 136. Furthermore, processors of the transmitter 120 and the receiver 130 respectively execute the above-mentioned program codes to achieve each function. For example, before the transmitter 120 transfers a file to the receiver 130, the processor of the transmitter 120 (here, the processor can be regarded as an embodiment of the hash value generating module 120) executes the specific software program. Therefore, the processor of the transmitter 120 executes the encrypting program code 125 to encrypt the file, execute the hash function code 123 to perform a hash function operation on the file for generating a hash value (for example, the above-mentioned hash value 8163), and adds the hash value to the file. And then, the transmitter 120 transfers the file to the receiver 130 through the network. The processor of the receiver 130 (here, it can be regarded as an embodiment of the detecting module 131 and the controlling module 132) executes the specific software program to receive the file. Therefore, the detecting program code 134 and the controlling program code 135 are executed at this time. That is, the detecting program code 134 is executed to obtain the hash value corresponding to the file, and the controlling program code 135 is executed to further compare the hash value with the look-up table 112 stored in the server. If the look-up table 112 comprises the record corresponding to the hash value (for example, the above-mentioned “only use for 30 days”), the processor of the receiver 130 executes the DRM program code 136 according to the record in order to impose a DRM operation on the file. In other words, the DRM program code 136 is executed to impose the access limitation, the above-mentioned “only use for 30 days”. At last, the processor of the receiver 130 executes the encrypting program code 138 of the specific program to decrypt the encrypted file into the original file for users to use.

Please note that the present invention file access controlling system is embodied through the hardware cooperating with the software. However, the present invention file access controlling system can be embodied through only hardware. The embodiment of hardware cooperating with the software is only regarded as an illustration, not a limitation.

Furthermore, in the look-up table 112, the present invention only needs characteristic data capable of distinguishing different files. The hash value is not necessary. For example, the present invention can utilize the file name or the file establishing time of the file to establish the needed look-up table 112. In other words, in the above-mentioned embodiment, the hash value is only used for illustration, and is not a limitation. Therefore, please note that the present invention hash value generating module 121 and the hash function code 123 are both utilized because of the hash value. In other words, if the hash value is no longer used, the present invention does not have to comprise the hash value generating module 121 and the hash function code 123. In other words, the hash value generating module 121 and the hash function code 123 are both optional devices, not limitations of the present invention.

Please note that the users of the receiver 130 may disconnect the connection between the receiver 130 and the server 110 for escaping from the present invention file access controlling method. The controlling module 132 can not compare the hash value with the look-up table. Therefore, in order to prevent the users of the receiver 130 from escaping the present invention file access controlling method, the present invention encrypts the file before transferring the file, and decrypts the encrypted file after the controlling module 132 completes comparing the hash value with the look-up table 112 and imposes an access limitation on the file. Therefore, the present invention can be embodied without the above-mentioned encryption and decryption operations. In other words, in above disclosures, the encrypting module 124, the encrypting program code 125, the decrypting module 137, and the decrypting program code 138 are all optional, and are not limitations of the present invention.

In addition, please note that the look-up table 112 is stored in the server 110. But in fact, the look-up table 112 can be stored in the transmitter 120 or the receiver 130, and can be updated by the service provider. This also is consistent with the spirit of the present invention. Furthermore, as shown in FIG. 1, the present invention file access controlling system 100 utilizes the transmitter 120, the receiver 130, and the server 110 to complete the access control of the file. But in fact, the present invention can only utilize the receiver 130 or the transmitter 120 to complete the access control of the file. For example, the transmitter 120 can calculate the hash value corresponding to the file and read the look-up table 112 for imposing the DRM operation on the file. And then, the transmitter 120 transfers the processed file to the receiver 130. At this time, the receiver 130 is only utilized for receiving the file. That is, the receiver 130 does not have to perform additional file access control. On the other hand, the receiver 130 can only be utilized for completing the aforementioned operation. That is, the transmitter 120 can only be utilized for transferring the file, and the transmitter 120 does not have to perform additional file access control. The above-mentioned changes all belong to the present invention.

In contrast to the prior art, the present invention file access controlling method and file access controlling system can accurately control the data or the file transferred on the network, and impose a predetermined process on the data or the file, which are not authorized, so that the unauthorized data or unauthorized media transferred in an peer-to-peer transmission on the network can be managed.

Those skilled in the art will readily observe that numerous modifications and alterations of the device and method may be made while retaining the teachings of the invention. Accordingly, the above disclosure should be construed as limited only by the metes and bounds of the appended claims.

1. A file access controlling method applied to a network for controlling access of a file transferred via a predetermined transmission scheme, the file access controlling method comprising:
(a) establishing a look-up table to store a plurality of records, wherein each record corresponds to a specific access limitation and specific characteristic data;
(b) obtaining characteristic data corresponding to the file; and
(c) comparing the characteristic data with the look-up table, and if the look-up table comprises a record corresponding to the characteristic data, imposing an access limitation on the file according to the file for controlling access of the file.

2. The file access controlling method of claim 1, wherein the access limitation is set through performing a digital rights management (DRM) operation.

3. The file access controlling method of claim 1, wherein the characteristic data is a hash value.

4. The file access controlling method of claim 3 further comprising:
generating the hash value and adding the hash value to the file according to contents of the file.

5. The file access controlling method of claim 3, wherein each hash value corresponds to each file.

6. The file access controlling method of claim 1, wherein the predetermined transmission scheme is a peer-to-peer transmission.

7. The file access controlling method of claim 1 being executed on a transmitter used for transferring the file.

8. The file access controlling method of claim 1 being executed on a receiver used for receiving the file.

9. The file access controlling method of claim 1 further comprising:
encrypting the file; and
after executing step (c), decrypting the file.

10. A file access controlling system applied to a network for controlling access of a file transferred via a predetermined transmission scheme, the file access controlling system comprising:
a first memory module for storing a look-up table, wherein the look-up table stores a plurality of records, where each record corresponds to a specific access limitation and specific characteristic data;
a detecting module for obtaining characteristic data corresponding to the file; and
a controlling module coupled to the first memory module and the detecting module for comparing the characteristic data with the look-up table, wherein if the look-up table comprises a record corresponding to the characteristic data, the controlling module imposing an access limitation on the file according to the record for controlling access of the file.

11. The file access controlling system of claim 10, wherein the detecting module and the controlling module are located in a processor, and the file access controlling system further comprises:
a second memory module for storing a detecting program code and a controlling program code;
wherein the detecting module executes the detecting program code for obtaining the characteristic data corresponding to the file, and the controlling module executes the controlling program code to compare the characteristic data with the look-up table for imposing the access limitation on the file in order to control access of the file.

12. The file access controlling system of claim 11, wherein the access limitation is set through executing the controlling program code by the controlling module to perform a digital rights management (DRM) operation.

13. The file access controlling system of claim 10 further comprising:
an encrypting module for encrypting the file; and
a decrypting module for decrypting module after comparing the characteristic data with the look-up table.

14. The file access controlling system of claim 13, wherein the detecting module, the controlling module, and the decrypting module are all located in a processor, and the file access controlling system further comprises:
a second memory module for storing a detecting program code, a controlling program code, and a decrypting program code;
wherein the controlling module executes the controlling program code to compare the characteristic data with the look-up table to impose the access limitation for accessing access of the file, and the decrypting module executes the decrypting program code to decrypt the file.

15. The file access controlling system of claim 14, wherein the characteristic data is a hash value.

16. The file access controlling system of claim 15 further comprising:
a hash value generating module for generating the hash value according to contents of the file and imposing the hash value on the file.

17. The file access controlling system of claim 16, wherein the hash value generating module is located in a transmitter used for transferring the file, and the detecting module and the controlling module are located in the receiver used for receiving the file.

18. The file access controlling system of claim 17, wherein the first memory module is located in a server or the receiver.

19. The file access controlling system of claim 16, wherein the hash value generating module, the detecting module, and the controlling module are all located in a transmitter used for transferring the file.

20. The file access controlling system of claim 19, wherein the first memory module is located in a server or the transmitter.

21. The file access controlling system of claim 16, wherein the hash value generating module, the detecting module, and the controlling module are all located in a receiver used for receiving the file.

22. The file access controlling system of claim 21, wherein the first memory module is located in a server or the receiver.

23. The file access controlling system of claim 14 further comprising:
a third memory module for storing a hash function code;
wherein the hash value generating module is located in a processor and executes the hash function code according to the content of the file for generating the hash value.

24. The file access controlling system of claim 15, wherein each hash value corresponds to each file.

25. The file access controlling system of claim 10, wherein the predetermined transmission scheme is a peer-to-peer transmission.

26. The file access controlling system of claim 10, wherein the characteristic data is a hash value.

27. The file access controlling system of claim 26, wherein each hash value corresponds to each file.
